(19) United States
(12) Patent Application Publication
(10) Pub. No.: US 2026/0339605 A1
(43) Pub. Date: Oct. 29, 2026

(54) METHOD AND SYSTEM FOR COMPUTING A BIT-WISE FLOATING POINT RECIPROCAL

(71) Applicant: Synaptics Incorporated, San Jose, CA (US)

(72) Inventors: Zacchaeus SCHEFFER, San Jose, CA (US); Deepak MITAL, Fremont, CA (US); Karthikeyan SHANMUGA VADIVEL, Los Gatos, CA (US)

(73) Assignee: Synaptics Incorporated, San Jose, CA (US)

(21) Appl. No.: 19/441,669

(22) Filed: Jan. 6, 2026

Related U.S. Application Data
(60) Provisional application No. 63/775,488, filed on Mar. 21, 2025.

(51) Int. Cl. G06F 7/483

(52) U.S. Cl. CPC G06F 7/483

(57) ABSTRACT

A method of computing a floating point reciprocal value may eliminate the need for specialized hardware. One or more masks may be created and one or more comparison values may be defined, the comparison values based on a floating point input value. A mantissa and an exponent may be generated, and a reciprocal value may be computed based on the masks, the comparison values, the floating point input value, the mantissa and the exponent. Use of a considerably smaller lookup table for use only in computing the mantissa considerably reduces the number of memory accesses and cycles required for computing the floating point reciprocal.

### CROSS-REFERENCE TO RELATED APPLICATIONS

This application claims the benefit of U.S. Provisional Application No. 63/775,488, entitled “Method and System for Computing a Bit-Wise Floating Point Reciprocal,” filed on Mar. 21, 2025, which is incorporated by reference herein in its entirety.

### TECHNICAL FIELD

The present implementations relate to generation of a reciprocal value of a floating point number using bit-wise operations.

### BACKGROUND OF RELATED ART

Machine learning (ML) is a field within artificial intelligence in which statistical algorithms are used to learn from data, which can then be generalized to unseen data. Machine learning algorithms, for example, are applied in many applications, such as natural language processing, speech recognition, email filtering, audio/video recognition, video summarization, etc. The workloads for performing machine learning operations are conventionally performed using hardware platforms, such as central processing units (CPUs) or graphics processing units (GPUs). The use of CPUs is generally preferable for general tasks that are to be performed in a fast, sequential manner. GPUs, on the other hand, use parallel processing and can separate complex problems into multiple smaller calculations that can be performed simultaneously. For massively distributed computational processes, as required for machine learning, GPUs are the current state of the art.

Machine Learning algorithms may require floating point arithmetic operations. Implementing floating point operations in hardware may be very expensive in terms of both silicon area and power consumption. Division and reciprocal operations may be especially complex, requiring specialized hardware.

There is a need for an implementation of a floating point reciprocal function with reduced silicon area and power consumption.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

As described herein, one aspect of the subject matter of this disclosure is implemented in a method for computing a bit-wise floating point reciprocal, which includes defining one or more mask values, the mask values to be used in a bit-wise operation, extracting, via one of the one or more mask values, a sign bit from a floating-point input value, converting the floating-point input value to an unsigned representation, defining one or more comparison operations, the comparison operations to compare the unsigned representation to a floating-point value, defining a mantissa index based on the unsigned representation, the one or more mask values and a result of the one or more comparison operations, defining a computed exponent, the computed exponent based on the unsigned representation, the one or more mask values and a result of the one or more comparison operations, and computing a reciprocal, the reciprocal to represent the arithmetic reciprocal of the floating-point input value, the reciprocal based on the unsigned representation, the sign bit, a result of the one or more comparison operations, the mantissa index and the computed exponent.

Another innovative aspect of the subject matter of this disclosure is implemented in a machine learning accelerator. An example machine learning accelerator includes at least one processor and a memory storing instructions for execution by the at least one processor. Execution of the instructions causes the machine learning accelerator to perform operations including receiving a request to perform a bitwise computation of a floating point reciprocal of a first binary number, converting the first binary number from a floating point representation into a first unsigned binary number having an unsigned numerical representation based at least in part on a sign bit associated with the first binary number, generating one or more Boolean comparison values based at least in part on the first unsigned binary number, determining a mantissa index based at least in part on the first unsigned binary number and on the one or more Boolean comparison values, the mantissa index indicating an entry in a mantissa lookup table (LUT) containing a mantissa corresponding to a first floating point reciprocal of the first binary number, determining an exponent value based at least in part on the first unsigned numerical representation and the one or more Boolean comparison values, the exponent value determined without use of a LUT, computing the first floating point reciprocal based at least in part on the sign bit, the one or more Boolean comparison values, the mantissa, and the exponent value, and providing the first floating point reciprocal in response to the received request.

Another innovative aspect of the subject matter of this disclosure is implemented in a method performed by a machine learning accelerator. An example method includes receiving a request to perform a bitwise computation of a floating point reciprocal of a first binary number, converting the first binary number from a floating point representation into a first unsigned binary number having an unsigned numerical representation based at least in part on a sign bit associated with the first binary number, generating one or more Boolean comparison values based at least in part on the first unsigned binary number, determining a mantissa index based at least in part on the first unsigned binary number and on the one or more Boolean comparison values, the mantissa index indicating an entry in a mantissa lookup table (LUT) containing a mantissa corresponding to a first floating point reciprocal of the first binary number, determining an exponent value based at least in part on the first unsigned numerical representation and the one or more Boolean comparison values, the exponent value determined without use of a LUT, computing the first floating point reciprocal based at least in part on the sign bit, the one or more Boolean comparison values, the mantissa, and the exponent value, and providing the first floating point reciprocal in response to the received request.

Another innovative aspect of the subject matter of this disclosure is implemented in a non-transitory computer readable storage medium storing instructions for execution by one or more processors of a machine learning accelerator. Execution of the instructions causes the machine learning accelerator to perform operations including receiving a request to perform a bitwise computation of a floating point reciprocal of a first binary number, converting the first binary number from a floating point representation into a first unsigned binary number having an unsigned numerical representation based at least in part on a sign bit associated with the first binary number, generating one or more Boolean comparison values based at least in part on the first unsigned binary number, determining a mantissa index based at least in part on the first unsigned binary number and on the one or more Boolean comparison values, the mantissa index indicating an entry in a mantissa lookup table (LUT) containing a mantissa corresponding to a first floating point reciprocal of the first binary number, determining an exponent value based at least in part on the first unsigned numerical representation and the one or more Boolean comparison values, the exponent value determined without use of a LUT, computing the first floating point reciprocal based at least in part on the sign bit, the one or more Boolean comparison values, the mantissa, and the exponent value, and providing the first floating point reciprocal in response to the received request.

### BRIEF DESCRIPTION OF THE DRAWINGS

The present implementations are illustrated by way of example and are not intended to be limited by the figures of the accompanying drawings.

FIG. 1 illustrates one of various examples of a floating point numerical representation.

FIG. 2 illustrates one of various examples of a method to generate a reciprocal value of a floating point number.

### DETAILED DESCRIPTION

In the following description, numerous specific details are set forth such as examples of specific components, circuits, and processes to provide a thorough understanding of the present disclosure. In the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

As discussed herein, machine learning operations are typically performed using hardware platforms, such as central processing units (CPUs) or graphics processing units (GPUs). In examples using smaller precision data formats such as BFloat16 and Float16, a full CPU or GPU may be an expensive solution to low-precision arithmetic operations. An accelerator may implement low-precision floating point operations without the need for a full CPU or GPU.

Various aspects as described herein relate to a machine learning accelerator architecture that includes a scalable processor that is fully programable, and therefore may be used with any desired artificial intelligence (AI) applications. The hardware of the machine learning accelerator is designed to efficiently process various machine learning operations and is designed to scale from low performance (less compute and hardware area) to high performance (larger compute) while maintaining high efficiency. Moreover, the machine learning accelerator is fully programmable via descriptors to implement various machine learning operations.

In the following description, 16 bit values may be written as follows, with underscore characters between each 4-bit nibble to improve readability: 0000_0000_0000_0000.

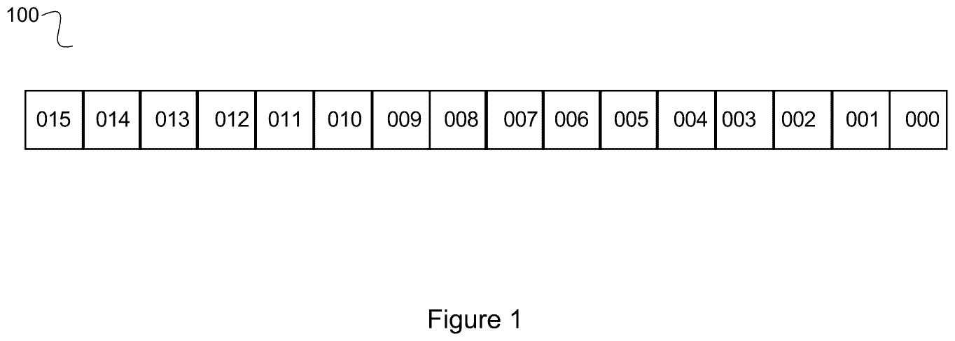

FIG. 1 illustrates one of various examples of a floating point numerical representation 100. A floating point number may be represented by the following expression: +/−s*M*B\hat{ }exp, where s represents a sign bit, M represents a mantissa, B represents a base value, and exp represents an exponent. In the following description, the base value B will be 2, but this is not intended to be limiting.

In FIG. 1, bit 015 may represent a sign bit s. In one of various examples, a sign bit s of binary value 1 may indicate a negative value, and a sign bit s of binary value 0 may indicate a positive value.

In FIG. 1, bits 014, 013, 012, 011, 010, 009, 008 and 007 may represent an exponent value exp. Bits 006, 005, 004, 003, 002, 001, and 000 may represent a mantissa M.

A floating-point representation as illustrated in FIG. 1 may include a bias value which may shift the exponent. As one of various examples, a bias of −127 may be used, so that an exponent of 3 may be represented as 130. The bias value may allow negative exponents to be stored without requiring a separate sign bit for the exponent value.

As one of various examples, a value of 14.75 may be represented using the floating point representation of FIG. 1. As 14.75 is a positive number, the sign bit may be set to 0. The value of 14.75 may be represented in binary form as 1110.11. This would then be normalized by shifting left by 3 bits to yield 1.11011*2\hat{ }3. The exponent may include a bias of −127, so that the exponent of 3 may be stored in the floating-point representation as 130. Combining the mantissa (11011), the exponent (10000010), and the sign bit would yield a final representation of 0100_0001_0001_1011.

Performing floating point division may be a complicated operation and may consume significant power and area resources in a hardware implementation. Floating point division techniques may include large lookup tables which may include reciprocal values for all possible mantissas for a given number representation.

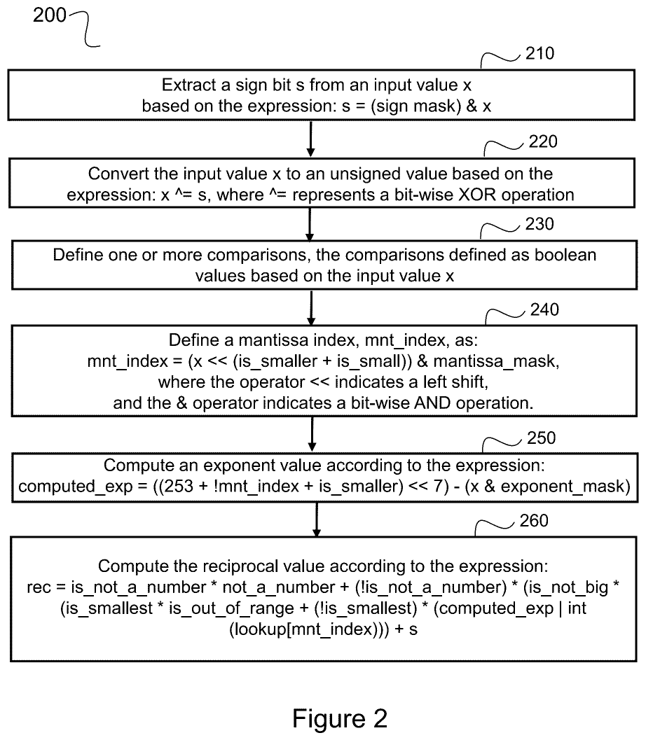

FIG. 2 illustrates one of various examples of a method to generate a reciprocal value of a floating point number. The example illustrated in FIG. 2 may utilize bitwise operations to generate a reciprocal value without the need for a large lookup table. The example illustrated in FIG. 2 utilizes 16-bit words and arithmetic, but this is not intended to be limiting.

One or more mask words may be defined, the mask words to be used in a hardware or software algorithm to mask specific bits in a 16-bit word. As one of various examples, a sign_mask may be defined as 1000_0000_0000_0000, the sign_mask to be used in a bit-wise AND operation to extract the sign bit from a 16-bit word. An exponent_mask may be defined as 0111_1111_1000_0000, the exponent_mask to be used in a bit-wise AND operation to extract an 8-bit exponent from a 16-bit word. In other examples, the exponent_mask may extract an exponent with more than 8 bits or fewer than 8 bits. A mantissa_mask may be defined as 0000_0000_0111_1111, the mantissa mask to be used in a bit-wise AND operation to extract a 7-bit mantissa from a 16-bit word. In other examples, the mantissa_mask may extract a mantissa with more than 7 bits or fewer than 7 bits.

One or more static values may be defined, including but not limited to an out_of_range_value defined as 0111_1111_1000_0000, and a not_a_number_value defined as 0111_1111_1100_0000. The out_of_range_value and the not_a_number_value may be used in comparison operations to determine the range of 16-bit values.

Static values may be defined based on a given number representation. For a BFloat16 representation, one set of static values may be used. For another representation, other static values may be used.

The following steps outline one of various examples of an algorithm to determine a reciprocal of an input value x. In operation, at step 210, a sign bit s may be extracted from the input value x based on the following expression: s=(sign_mask) & x.

At step 220, the input value x may be converted to an unsigned value based on the following expression: x \hat{ }=s, where \hat{ }=represents a bit-wise XOR operation.

At step 230, one or more comparisons may be defined, the comparisons defined as boolean values based on the input value x. The comparisons may include an is_not_a_number comparison, defined based on the expression: is_not_a_number=x>out_of_range_value, the out_of_range value as defined previously. The comparisons may include an is_not_big comparison, defined based on the expression: is_not_big=x<0111_1110_10000001. The comparisons may include an is_small comparison, defined based on the expression: is_small=x<0000_0000_1000_0000. The comparisons may include an is_smaller comparison, defined based on the expression: is_smaller=x<0000_0000_0100_0000. The comparisons may include an is_smallest comparison, defined based on the expression: is_smallest=x<0000_0000_0010_0000.

Comparisons may be defined based on a given number representation. For a bfloat16 representation, one set of comparisons may be used. For another representation, other comparisons may be used.

At step 240, a mantissa index, mnt_index, may be defined as mnt_index=(x<<(is_smaller+is_small)) & mantissa_mask, where the operator << indicates a left shift, and the & operator indicates a bit-wise AND operation. Arithmetic operations in step 240 may be performed as integer arithmetic.

At step 250, a computed exponent value may be computed according to the following expression: computed_exp=((253+!mnt_index+is_smaller)<<7)−(x & exponent_mask). Arithmetic operations in step 250 may be performed as integer arithmetic.

At step 260, the reciprocal value (called rec, and representing the arithmetic value 1/x) may be computed according to the following expression: rec=is_not_a_number*not_a_number+(! is_not_a_number)*(is_not_big*(is_smallest*is_out_of_range+(!is_smallest)*(computed_exp|int(lookup[mnt_index)))+s. Arithmetic operations in step 260 may be performed as integer arithmetic.

In the preceding expression, the operator “|” specifies a bit-wise OR operation, the operator “*” represents an arithmetic multiplication, the “+” operator specifies an arithmetic addition, and the operator “!” represents a logical not.

The preceding description describes specific values for masks and comparisons, but this is not intended to be limiting. Other examples may use different values for the not_a_number_value and the out_of_range_value. Other examples may use different values for the is_not_a_number, is_out_of_range, is_not_big, is_small, is_smaller, and is_smallest comparisons.

The result of the method illustrated in FIG. 2 is a floating-point representation, but individual arithmetic operations in the method may be performed as integer arithmetic operations.

According to some implementations of the present invention, to calculate 1/x, exemplary embodiments of the present invention can pick apart a given BFloat value, calculate the exponent of the result, and then fill in the mantissa using a lookup table (LUT). Since BFloat values have seven bits of mantissa, the LUT can be, for example, 128 bytes long. Use of such a 128-byte LUT can be faster, require lower energy, and save memory. Merely for purposes of illustration, the following provides example pseudocode that can be used according to embodiments of the present invention:
sgn=0b1000000000000000 #sign bit
exp=0b0111111110000000 #exponent bits
mnt=0b0000000001111111 #mantissa bits
inf=0b0111111110000000
nan=0b0111111111000000
m_lut_int= . . . #LUT for 1/x mantissa
def one_over_x(x):
   s=sgn & x #store sign bit
   x \hat{ }=s #unsigned x
   is_nan=x>inf
   is_not_big=x<0b0111111010000001
   is_small=x<0b0000000010000000
   is_smaller=x<0b0000000001000000
   is_smallest=x<0b0000000000100000
   mnt_index=(x<<(is_smaller+is_small)) & mnt
   computed_exp=((253+(!mnt_index)+is_smaller)<<7)−(x & exp)
   return is_nan*nan+(!is_nan)*(
      is_not_big*(
         is_smallest*inf+(!is_smallest)*(
         computed_exp|int(m_lut_int[mnt_index])
         )
      )+s
         where sgn represents sign_mask, exp represents exponent_mask, mnt represents mantissa_mask, inf represents out_of_range_value, nan represents not_a_number_value, m_lut_int represents the lookup operation, is_nan represents is_not_a_number, and #represents a comment. The value returned by the aforementioned pseudocode is rec, which represents the arithmetic value 1/x.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may include random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, circuits, and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine, any of which being capable of executing scripts or instructions of one or more software programs stored in memory that when executed cause it to perform one or more functions as described herein and to operate as a special-purpose processor. Unless specifically stated otherwise as apparent from the following discussions, it is appreciated that throughout the present application, discussions utilizing the terms such as “accessing,” “receiving,” “transmitting,” “transferring,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. Further, the term “coupled” as used herein means connected directly to or connected through one or more intervening components or circuits. The terms “electronic system” and “electronic device” may be used interchangeably to refer to any system capable of electronically processing information.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A machine learning accelerator, comprising:
at least one processor; and
a memory storing instructions that, when executed by the at least one processor, cause the machine learning accelerator to perform operations comprising:
receiving a request to perform a bitwise computation of a floating point reciprocal of a first binary number;
converting the first binary number from a floating point representation into a first unsigned binary number having an unsigned numerical representation based at least in part on a sign bit associated with the first binary number;
generating one or more Boolean comparison values based at least in part on the first unsigned binary number;
determining a mantissa index based at least in part on the first unsigned binary number and on the one or more Boolean comparison values, the mantissa index indicating an entry in a mantissa lookup table (LUT) containing a mantissa corresponding to a first floating point reciprocal of the first binary number;
determining an exponent value based at least in part on the first unsigned numerical representation and the one or more Boolean comparison values, the exponent value determined without use of a LUT;
computing the first floating point reciprocal based at least in part on the sign bit, the one or more Boolean comparison values, the mantissa, and the exponent value; and
providing the first floating point reciprocal in response to the received request.

2. The machine learning accelerator of claim 1, wherein execution of the instructions causes the machine learning accelerator to perform operations further comprising identifying one or more mask values, the one or more mask values defined to mask specific bits in the first binary number, wherein the one or more mask values comprise a sign mask, an exponent mask, and a mantissa mask.

3. The machine learning accelerator of claim 2, wherein the sign bit is determined based on a logical AND operation between the sign mask and the first binary number, wherein an exponent word is determined based on a logical AND operation between the exponent mask and the first binary number, and wherein a mantissa word is determined based on a logical AND operation between the mantissa mask and the first binary number, wherein each bit of the first binary number is a part of only one of the sign bit, the exponent word, and the mantissa word.

4. The machine learning accelerator of claim 1, wherein the one or more Boolean comparison values comprise an is_small value indicating whether or not the first unsigned binary number is less than a first threshold static value, an is_smaller value indicating whether or not the first unsigned binary number is less than a second threshold static value less than the first threshold static value.

5. The machine learning accelerator of claim 4, wherein the first binary number is a 16 bit floating point number having an 8-bit exponent, and a 7-bit mantissa, the first threshold static value is 0000_0000_1000_0000, and the second threshold static value is 0000_0000_0100_0000.

6. The machine learning accelerator of claim 4, wherein the mantissa index is determined as mnt_index=(x<<(is_smaller+is_small) & mantissa_mask, where the operator << indicates a left shift, + indicates arithmetic addition, & indicates a bitwise AND operation, and mantissa_mask is a binary mask configured to zero out all bits of the first binary number which are not associated with a mantissa of the first binary number.

7. The machine learning accelerator of claim 6, wherein the exponent value is determined as exponent_value=((number_of_values+!mnt_index+is_smaller)<<mantissa_word_size)−(x & exponent_mask), where x is the first unsigned binary number, number_of_values is a number of allowable numerical values for floating point numbers having a length of the first binary number, ! indicates binary inversion, + indicates arithmetic addition, << indicates a left shift, − indicates arithmetic subtraction, mantissa_word_size is a number of bits of the first binary number associated with the mantissa, & indicates bitwise AND, and exponent_mask is a binary mask configured to zero out all bits of the first binary number which are not associated with an exponent of the first binary number.

8. The machine learning accelerator of claim 7, wherein the first binary number has 16 bits comprising a sign bit, an 8-bit exponent, and a 7-bit mantissa, number_of_values is 253, and mantissa_word_size is 7.

9. The machine learning accelerator of claim 7, wherein the one or more Boolean comparison values further comprise an is_not_a_number value indicating whether or not the first unsigned binary number has an value corresponding to a static not_a_number value, an is_out_of_range value indicating whether or not the first unsigned binary number exceeds a static out_of_range value, an is_not_big value indicating whether or not the first unsigned binary number is less than a third threshold static value.

10. The machine learning accelerator of claim 9, wherein the first binary number is a 16 bit floating point number having an 8-bit exponent, and a 7-bit mantissa, the static not_a_number value is 0111_1111_1100_0000, the static out_of_range value is 0111_1111_1000_0000, and the third threshold static value is 0111_1110_1000_0001.

11. The machine learning accelerator of claim 9, wherein the first floating point reciprocal fp_reciprocal is determined as fp_reciprocal=(is_not_a_number*not_a_number)+(!is_not_a_number)*(is_not_big*(is_smallest*is_out_of_range+(! is_smallest)*(exponent_value|int(lookup[mnt_index]))))+s, wherein x is the first unsigned binary number, * indicates arithmetic multiplication, + indicates arithmetic addition, ! indicates binary inversion, | indicates bitwise OR, int( ) indicates conversion to an integer value, and lookup[mnt_index] represents an output of the mantissa LUT at index mnt_index.

12. A method performed by a machine learning accelerator, the method comprising:
receiving a request to perform a bitwise computation of a floating point reciprocal of a first binary number;
converting the first binary number from a floating point representation into a first unsigned binary number having an unsigned numerical representation based at least in part on a sign bit associated with the first binary number;
generating one or more Boolean comparison values based at least in part on the first unsigned binary number;
determining a mantissa index based at least in part on the first unsigned binary number and on the one or more Boolean comparison values, the mantissa index indicating an entry in a mantissa lookup table (LUT) containing a mantissa corresponding to a first floating point reciprocal of the first binary number;
determining an exponent value based at least in part on the first unsigned numerical representation and the one or more Boolean comparison values, the exponent value determined without use of a LUT;
computing the first floating point reciprocal based at least in part on the sign bit, the one or more Boolean comparison values, the mantissa, and the exponent value; and
providing the first floating point reciprocal in response to the received request.

13. The method of claim 12, further comprising identifying one or more mask values, the one or more mask values defined to mask specific bits in the first binary number, wherein the one or more mask values comprise a sign mask, an exponent mask, and a mantissa mask.

14. The method of claim 13, wherein the sign bit is determined based on a logical AND operation between the sign mask and the first binary number, wherein an exponent word is determined based on a logical AND operation between the exponent mask and the first binary number, and wherein a mantissa word is determined based on a logical AND operation between the mantissa mask and the first binary number, wherein each bit of the first binary number is a part of only one of the sign bit, the exponent word, and the mantissa word.

15. The machine learning accelerator of claim 12, wherein the one or more Boolean comparison values comprise an is_small value indicating whether or not the first unsigned binary number is less than a first threshold static value, and an is_smaller value indicating whether or not the first unsigned binary number is less than a second threshold static value less than the first threshold static value.

16. The machine learning accelerator of claim 15, wherein the mantissa index is determined as mnt_index=(x<<(is_smaller+is_small) & mantissa_mask, where x is the first unsigned binary number, << indicates a left shift, + indicates arithmetic addition, & indicates a bitwise AND operation, and mantissa_mask is a binary mask configured to zero out all bits of the first binary number which are not associated with a mantissa of the first binary number.

17. The machine learning accelerator of claim 16, wherein the exponent value is determined as exponent_value=((number_of_values+!mnt_index+is_smaller)<<mantissa_word_size)−(x & exponent_mask), where x is the first unsigned binary number, number_of_values is a number of allowable numerical values for floating point numbers having a length of the first binary number, ! indicates binary inversion, + indicates arithmetic addition, << indicates a left shift, − indicates arithmetic subtraction, mantissa_word_size is the number of bits of the first binary number associated with the mantissa, & indicates bitwise AND, and exponent_mask is a binary mask configured to zero out all bits of the first binary number which are not associated with an exponent of the first binary number.

18. The machine learning accelerator of claim 17, wherein the one or more Boolean comparison values further comprise an is_not_a_number value indicating whether or not the first unsigned binary number has an value corresponding to a static not_a_number value, an is_out_of_range value indicating whether or not the first unsigned binary number exceeds a static out_of_range value, an is_not_big value indicating whether or not the first unsigned binary number is less than a third threshold static value.

19. The machine learning accelerator of claim 18, wherein the first floating point reciprocal fp_reciprocal is determined as fp_reciprocal=(is_not_a_number*not_a_number)+(!is_not_a_number)*(is_not_big*(is_smallest*is_out_of_range+(! is_smallest)*(exponent_value|int(lookup[mnt_index]))))+s, wherein x is the first unsigned binary number, * indicates arithmetic multiplication, + indicates arithmetic addition, ! indicates binary inversion, | indicates bitwise OR, int( ) indicates conversion to an integer value, and lookup[mnt_index] represents an output of the mantissa LUT at index mnt_index.

20. A non-transitory computer-readable storage medium storing instructions for one or more processors of a machine learning accelerator, wherein execution of the instructions by the one or more processors causes the machine learning accelerator to perform operations comprising:
receiving a request to perform a bitwise computation of a floating point reciprocal of a first binary number;
converting the first binary number from a floating point representation into a first unsigned binary number having an unsigned numerical representation based at least in part on a sign bit associated with the first binary number;
generating one or more Boolean comparison values based at least in part on the first unsigned binary number;
determining a mantissa index based at least in part on the first unsigned binary number and on the one or more Boolean comparison values, the mantissa index indicating an entry in a mantissa lookup table (LUT) containing a mantissa corresponding to a first floating point reciprocal of the first binary number;
determining an exponent value based at least in part on the first unsigned numerical representation and the one or more Boolean comparison values, the exponent value determined without use of a LUT;
computing the first floating point reciprocal based at least in part on the sign bit, the one or more Boolean comparison values, the mantissa, and the exponent value; and
providing the first floating point reciprocal in response to the received request.
